(19) United States
(12) Patent Application Publication
(10) Pub. No.: US 2024/0403857 A1
(43) Pub. Date: Dec. 5, 2024

(54) SYSTEMS AND METHODS FOR AGGREGATE ROUTING AMONG INTERCONNECTING DIRECTORIES

(71) Applicant: VOCALINK INTERNATIONAL LIMITED, LONDON (GB)

(72) Inventors: David Andrew Bray, Hertfordshire (GB); Boy Anthony Kuhne, London (GB); Tung Hei Kwan, Berkshire (GB)

(21) Appl. No.: 18/678,970

(22) Filed: May 30, 2024

Related U.S. Application Data
(60) Provisional application No. 63/470,263, filed on Jun. 1, 2023.
(60) Provisional application No. 63/470,343, filed on Jun. 1, 2023.

(51) Int. Cl. G06Q 20/32

(52) U.S. Cl. CPC G06Q 20/322

(57) ABSTRACT

Systems and methods are provided for aggregate routing in response to requests associated with interconnecting directories. One example computer-implemented method includes receiving, from a participant, a proxy lookup request, the proxy lookup request including a proxy; submitting the proxy lookup request to each of multiple directories; determining that a proxy lookup response has been received from each of the multiple directories; and in response, aggregating the proxy lookup responses into an aggregate proxy lookup response; and returning the aggregate proxy lookup response, to the participant, in response to the proxy lookup request.

### CROSS-REFERENCE TO RELATED APPLICATIONS

This application claims the benefit of, and priority to, U.S. Provisional Application No. 63/470,263, filed Jun. 1, 2023, and U.S. Provisional Application No. 63/470,343, filed Jun. 1, 2023. The entire disclosure of each of the above applications is incorporated herein by reference.

### FIELD

The present disclosure is generally directed to systems and methods for providing aggregate routing in responses to requests among interconnecting directories.

### BACKGROUND

This section provides background information related to the present disclosure which is not necessarily prior art.

Data structures are known for storing data, whereby the data may be retrieved in response to a request for the particular data. When a request for data is received, the different data structures are each queried to determine which data structure includes the data identified in the request. The data may be included in a local data structure, or one or more remote data structures, whereby each is searched one after the other, sequentially or according to some order. When the data structure is identified, the data is retrieved and returned in response to the request.

### DRAWINGS

The drawings described herein are for illustrative purposes only of selected embodiments and not all possible implementations, and are not intended to limit the scope of the present disclosure.

FIG. 1 illustrates an example system of the present disclosure suitable for use in aggregate routing in response to requests associated with proxies among interconnecting directories and/or in resolution of proxies among interconnecting directories across multiple different schemes;

FIG. 2 is a block diagram of an example computing device that may be used in the system of FIG. 1;

FIG. 3 illustrates an example method, which may be implemented in connection with the system of FIG. 1, for use in aggregate routing in response to a requests associated with interconnecting directories; and

FIG. 4 illustrates an example method, which may be implemented in connection with the system of FIG. 1, for use in resolving proxies across multiple schemes.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Data structures may include directories of specific data, such as, for example, identifying data and proxies specific to the identifying data. The data structures, in turn, may be separate in the context of geographic location, ownership and/or control, such that access to particular data involves a particular data structure. It is problematic, in various implementations, to pull data from various different directories. For instance, in connection with a request, a proxy may be associated with data in various directories, whereby resolving the data across the multiple directories delays response to the request, which may limit the ability of the data structure to participate in real time payment (RTP) transactions, based on delay and/or combined resolution of the proxies.

Uniquely, the systems and methods herein provide for aggregating responses from the different directories or from other payment data sources, etc. In particular, in one example embodiment, a computing device seeks resolution of a proxy from various participants and/or third parties (or service cores in other schemes, for example) and tracks the responses from those various participants and/or third parties. The responses, when received and/or after an interval, are aggregated and provided in response to the request. In this manner, the proper, expected, or intended resolution of the proxies, through multiple directories, is permitted, while preserving ability to process RTP transactions. That said, it should be appreciated that in other example embodiments, such aggregation of responses (through use of the proxy or other reference data) may also, or additionally, be used in connection with account verification, confirmation of payees, sanction checking against names, etc.

Further, data structures may include directories of specific data, such as, for example, identifying data and proxies specific to the identifying data. The data structures, in turn, may be separate in the context of geographic location, ownership and/or control, such that access to particular data involves a particular data structure. It is problematic, in various implementations, though, to identify the specific data structure, for a given request, especially when the data structure is identified from numerous different data structures associated with different parties and/or located in different jurisdictions (e.g., cross-border, etc.).

Uniquely, the systems and methods herein provide for interconnecting directories, through one or more service cores, across multiple different schemes, for example, to enable resolution of proxies across the multiple different schemes. In connection therewith, the different schemes may include different countries, region, borders, currencies, etc. That said, it should be appreciated that in other example embodiments, such interconnection of directories may also be used be used in connection with account verification, confirmation of payees, sanction checking against names, etc.

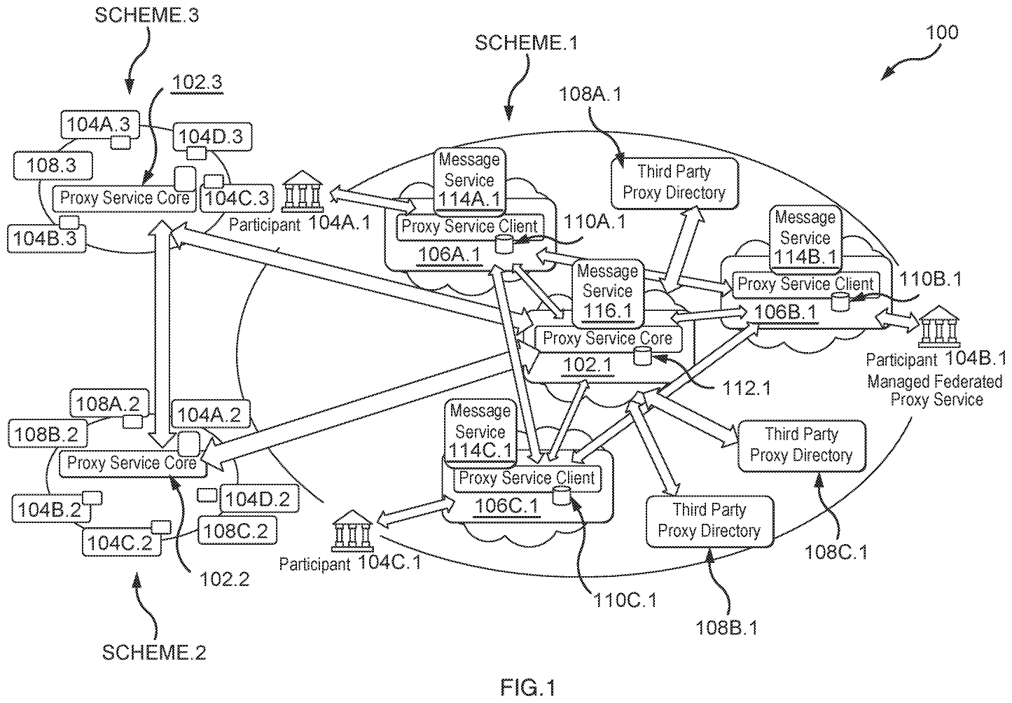

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, distribution of directories in or between different schemes, relations among participants, privacy concerns and/or requirements, etc.

The illustrated system 100 generally includes multiple schemes (e.g., SCHEME.1, SCHEME.2, SCHEME.3, etc.) each including a proxy service core 102 (e.g., 102.1, 102.2, 102.3, etc.), multiple participants 104A-104D (e.g., 104A.1, 104B.1, 104A.2, 104B.2, 104A.3, 104B.3, 104C.3, 104D.3, etc.), multiple proxy service clients 106A-106C (e.g., 106A.1, 106B.1, 106C.1, etc.), and multiple third party (or 3rd party) proxy directory 108 (e.g., 108A.1, 108B.1, 108C.1, 108A.2, 108B.2, 108C.2, etc.), each of which is coupled to one or more networks. The network(s) (as indicated by the arrowed lines in FIG. 1) may include, without limitation, one or more of a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof, etc.

While the example of FIG. 1 is provided for (or in the context of) proxies, it should be appreciated that any suitable account data or account related data or, more generally, reference data, may be used instead of proxies, whereby the proxy service cores and the proxy service clients may broadly be considered service cores and service clients, i.e., not specific to proxies. And, whether based on proxies or other reference data, the service cores and the service clients may cooperate with one another and/or with third party directories (as generally described herein) to provide for resolution of payment data (or other data), account verification, confirmation of payees, sanction checking against names, and/or other services associated with or related to payments. That said, it should be understood that the term proxy as used herein may be inclusive of any reference data, which is linked to any other data and which is not specifically linked to phone numbers, email addresses, etc. (e.g., a proxy may include any reference data by which other data may be accessed, etc.).

In this example embodiment, for each scheme, the participant 104A (e.g., participant 104A.1, etc.), for example, includes a banking institution, or bank or other financial institution, which is associated with various users (or customers) (not shown). In particular, the participant 104A is configured to issue accounts to users, and the accounts are each associated with a unique account identifier (e.g., account number (alone or in combination with a routing number), primary account number (PAN), virtual account number, wallet identification number, etc.), alone or in combination with expiration dates, verification codes, etc., (broadly, account data). Account data should be understood to be any identifying data associated with an account, from which the account may be identified, based on the account data, alone or in combination with other data. The accounts may be credit accounts, debit accounts, prepaid accounts, checking accounts, or other types of financial/currency accounts, which are issued by the participant 104A, for example, to fund a transaction (e.g., purchase, money transfer, etc.) by the various users.

In connection therewith, the participant 104A is configured to link the account data to a proxy. A proxy may include, for example, data known to the user, and unique to the user. In this example, the proxy includes a phone number, or more specifically, a mobile phone number, but may include, in other examples, an email address, government-issued number/identifier, account verification information, or other numeric, alpha or alpha-numeric string, etc. In another example, the proxy may include an international bank account number or IBAN. The proxy is stored in database 110A (e.g., database 110A.1, etc.) associated with the proxy service client 106A (e.g., proxy service client 106A.1, etc.), as explained more below. In general, the proxy may include any type of alias linked to the account data, etc.

The participant 104A is configured, by the proxy service client 106A, to store the proxy in a proxy directory, for example, in the database 110A.

That is, the participant 104A is configured, by the proxy service client 106A, to store the proxy in a proxy directory (i.e., as a federated directory) in database 110A (e.g., database 110A.1, etc.), as shown in FIG. 1, and to register one or more proxies for different account/users. In this way, the participant 104A is configured to associate or link the proxy in the proxy directory to account data for the user, whereby a directory data structure is stored in the database 110A. In order to extend the usability of the proxy (e.g., to other participants, etc.), the participant 104A is further configured, by the proxy service client 106A, to submit the proxy to the proxy service core 102 (e.g., proxy service core 102.1, etc.) for registration. The proxy service core 102, in turn, is configured to store the proxy in a database 112 (e.g., database 112.1, etc.), in association with the participant 104A (e.g., a proxy reference address/identifier associated with the participant 104A, etc.), in a local registry in the database 112.

Notably, however, the account data is not submitted by the participant 104A to the proxy service core 102 as part of the registration in this embodiment, whereby the proxy service core 102 is configured to query the participant 104A, to determine the account data that is linked to the proxy, in response to a request including the proxy (e.g., as submitted by a proxy requestor, etc.). In this manner, the participant 104A, by the proxy service client 106A, is configured to manage the proxy directory included in the database 110A (e.g., as a federated service, etc.). That said, in other embodiments, the participant 104A may be configured, by the proxy service client 106A, to submit the proxy and account data to the proxy service core 102, whereby the proxy service core 102 is configured to store the proxy and account data in the database 112, and whereby the proxy service core 102 is permitted to solve the proxy with limited, or no, interaction with the participant 104A.

In this example embodiment, the system 100 includes multiple message services 114 (e.g., service 114A.1, service 114B.1, service 114C.1 in SCHEME.1, etc.), each of which is configured to create, compile, transmit, transform, etc., messages between either of the participants 104 and the third party proxy directory 108 (e.g., 108A.1, 108B.1, 108C.1, 108A.2, 108B.2, 108C.2, etc.) and the proxy service core 102 (e.g., 102.1, 102.2, 102.3, etc.), in the respective schemes, etc.

For example, the message service 114A.1 is configured (or cooperates with the proxy service client 106A.1) to transform messages from the participant 104A.1 (e.g., registry requests, proxy lookup requests, etc.) from a format native to the participant 104A.1 (e g., ISO 20022 standard format message, or any other message format, etc.) (e.g., a first format, etc.) to an internal format of the proxy service core 102.1 (e.g., a proprietary format, etc.) (e.g., a second format, etc.), which is different than the native format. In connection therewith, in some examples, the transformation may be consistent with an application programming interface (API) call/request. For instance the internal message format may include an API format, whereby the internal messaging is consistent with an API call.

The message service 114A.1 is also configured (or also cooperates with the proxy service client 106A.1) to transform messages back, when flowing in the opposite direction. In this manner, the participant 104A.1, for example, is permitted to communicate in a native format, as are other participants (in other, different native formats particular to the other participants), while the internal messaging among the proxy service core 102.1 and the proxy service client 106A.1 are the same, in this example embodiment, regardless of scheme (e.g. proxy service client 106A.1 versus proxy service core 102.3 versus proxy service client 106C.2, etc.). In this was, the participant 104A.1, for example, is not required, or directed, to know anything about the format, form or conventions of messaging in a scheme in which the proxy may be resolved. The proxy service core 102, proxy service clients 106, and the message service 114 are configured to cooperate to conduct the necessary transformations/messaging.

It should also be appreciated that the proxy service core 102.1 may also be associated with a message service 116.1 (e.g., more general to the SCHEME.1, etc.), where the message service 116.1 may then be configured to create, compile, transmit, transform, etc., messages from third parties or participants, etc. that that do not have proxy service clients included or associated therewith (e.g., participants that rely on the proxy service core 102.1 as their proxy directory, etc.).

That said, the message services 114 may be configured to communicate and/or transform messages according to any suitable format, as required or desired for the proxy service core 102 to perform as described herein.

It should be further appreciated that in this example embodiment, the participants 104B and 104C are configured similar to participant 104A, as it pertains to the proxies. As such, the participants 104B and 104C include databases 110B, 110C, respectively (e.g., 110B.1, 110C.1, etc.), which include a proxy directory of proxies registered with the proxy service core 102 and linked to account data of the respective participant.

It should be appreciated that in one or more embodiments another participant may be configured to rely on the proxy service core 102 to manage the proxy directory, to link proxies to accounts issued by that participant, and to resolve proxy lookup requests, whereby the participant is different than any of the participants 104A-104C.

In addition, in FIG. 1, as indicated above, three different schemes are illustrated, each with a respective proxy service core 102. In SCHEME.1, the proxy service core 102.1 and the participants 104A.1-104C.1 and third party directory 108.1 are bound together by a circle, which is representative of a first scheme, or SCHEME.1. The system 100 also includes a second scheme, or SCHEME.2, and a third scheme, or SCHEME.3, which are similar to and/or the same as SCHEME.1. In connection therewith, for purposes of illustration, each of the parts of SCHEME.1 should be understood to be functionally and/or generally the same in SCHEME.2 and SCHEME.3 (yet different, in that, for example, the participant 104A. 1 is different than participant 104A.2 and the participant 104A.3). That said, it should be appreciated that descriptions of the proxy service core 102, for example, are generic to proxy service core 102.1 and 102.2 and 102.3, while description of proxy service core 102.1 or proxy service core 102.2 or the proxy service core 102.3 will often be specific to that proxy service core. The same applies to the descriptions of the participants 104, the proxy service clients 106, and the third parties 108, etc.

It should be appreciated that the participants 104A-104C are included in FIG. 1 for purposes of illustration, and that there may be a different number of participants in other embodiments, whether in a particular scheme, or in different schemes.

Each scheme may be specific to a proxy service core and may be defined, for example, by a particular geographic boundary or governmental or geopolitical boundary (e.g., country, state, territory, city, continent, postal code), or limited to a particular type of participant(s) or service (e.g., for which a proxy is requested, etc.) (e.g., a particular currency type, etc.). It should also be appreciated that the proxy service cores 102.1, 102.2, and 102.3 are configured to communicate with one another, as indicated by the arrowed lines in FIG. 1. In general, the system 100 may provide a global solution for proxy lookup, where the schemes (e.g., SCHEME.1, SCHEME.2, SCHEME.3, etc.) are each specific to a region such as, for example, a country or portion of a country. In this manner, each region and/or country may be associated with a scheme, whereby each of the schemes operates consistent with the description herein. For example, where one SCHEME.1 is the United Kingdom (as indicated by the +44 country code), and SCHEME.2 is Sweden (as indicated by +46 country code) and SCHEME.3 is Netherlands (as indicated by +31 country code), as should be apparent from FIG. 1, the schemes are coupled in communication to provide proxy lookup across the different countries, or potentially, globally (whereby the schemes may be identified by the particular country code included in a corresponding user phone number, etc.). It should be appreciated that the proxy service core 102.2 and the proxy service core 102.3 may communicate with each other in the same manner as described for the proxy service core 102.1 and the proxy service core 102.2 (or the proxy service core 102.3), etc. Further, it should be appreciated that any of the proxy service cores 102.1, 102.2, and 102.3 may communicate in the same manner with one or more other proxy service cores of other schemes not illustrated in FIG. 1, etc.

The proxy service core 102 is also configured to orchestrate messages within the system 100 (e.g., via routing rules (or routing logic), etc.). In particular, the proxy service core 102 is configured to compile and/or route the messages (e.g., determine where to route the messages, etc.) within the system 100, for example, to particular participants 104A-104C, to other parts of the system 100, etc. (e.g., via multi-lateral routing, etc.).

In the exemplary embodiment, the proxy service core 102 is further configured to communicate with the third party proxy directory(ies) 108 (e.g., broadcast the proxy lookup request, etc.). The third party proxy directory(ies) 108 include a proxy directory for accounts, which, like above, includes proxies linked to account data. That said, in some examples the third party proxy directory 108 may include, for instance, any directory (e.g., a single unfederated directory, etc.), which is connected (or otherwise in communication with) the proxy service core 102, but that is not controlled in whole or in part by the proxy service core 102 (e.g., it may not be indexed and/or does not include routing rules, etc.). To this point, the third party proxy directory 108 may include a legacy directory from a payment network (e.g., that is managed on behalf of a scheme in the same or a different country, etc.) or a directory managed for a third party organization (e.g., such as a scheme or mobile payments provider such as YAPE, PLIN, Zelle, etc.; etc.). In other examples, the third party proxy directory 108 may include a federated directory, for instance, where the directory 108 implements one or more client service as identified, described, or eluded to herein.

It should be further noted that each of the proxy service client 106A, the proxy service client 106B, and the proxy service client 106C includes a rules data structure (and/or related rules engine). The rules data structures are configured to store one or more rules related to identifying a proxy to a specific scheme, in which the proxy is to be resolved (e.g., a native scheme of the proxy, etc.). The rules are described in more detail below. That said, in some example embodiments, the rules data structures (and/or related rules engines) may be included in the respective databases 110A, 110B, 110C, etc. Further, in some example embodiments, similar rules data structures (and/or related rules engines) may be included in the proxy service core 102.

It should be appreciated that the participants 104A-104C are included in FIG. 1 for purposes of illustration, and that there may be a different number of participants in other embodiments, whether in a particular scheme, or in different schemes. It should be further understood that other system embodiments generally includes tens, hundreds, or thousands, or more or less participants.

The proxy service core 102 is further configured to communicate with the third party proxy directory 108 (e.g., 108A.1, etc.). The third party proxy directory 108 includes a proxy directory for accounts, which, like above, includes proxies linked to account data. That said, in some examples, the third party proxy directory 108 may include, for instance, any directory (e.g., a single unfederated directory, etc.), which is connected (or otherwise in communication with) the proxy service core 102, but that is not controlled in whole or in part by the proxy service core 102 (e.g., it may not be indexed and/or does not include routing rules, etc.). To this point, the third party proxy directory 108 may include a legacy directory from a payment network (e.g., that is managed on behalf of a scheme in the same or a different country, etc.) or a directory managed for a third party organization (e.g., such as a scheme or mobile payments provider such as YAPE, PLIN, Zelle, etc.; etc.). In other examples, the third party proxy directory 108 may include a federated directory, for instance, where the directory 108 implements one or more client services as identified, described, or eluded to herein.

In addition in FIG. 1, as indicated above, the system 100 includes three separate schemes, which are illustrated, each with a respective proxy service core 102. The proxy service core 102.1 and the participants 104A.1-104B.1, along with the third parties 108A1-108A.3, are bound together by a circle, which is representative of a first scheme, or SCHEME.1. The system 100 also includes a second scheme, or SCHEME.2, and a third scheme, or SCHEME.3, which are similar, as it pertains to the components therein, to SCHEME.1. In connection therewith, for purposes of illustration, each of the components of SCHEME.1 should be understood to be functionally and/or generally the same in SCHEME.2 and SCHEME.3 (yet different, in that, for example, the participant 104A.1 is different than participant 104A.2), but potentially, with different numbers of the respective components.

It should be appreciated that the schemes may be defined otherwise in other embodiments. For example, the scheme may instead be service-based, rather than geography-based. More generally, the different schemes may be delineated by restrictions, regulations, services accessibility, etc.

In this example embodiment, in connection with a real-time payment transaction, the proxy service core 102 is configured to resolve proxies through messaging within the system 100, for example, to/from particular participants 104A-104B, the third parties 108, and/or other parts of the system 100, etc.

In particular, a first user (e.g., sender, etc.) (not shown) requests a real-time transaction, in which funds are to be exchanged with a second user (e.g., recipient, etc.) (not shown). The request includes a proxy for an account of the recipient, or recipient account, which in this example, includes a phone number or an email address, etc. As noted above, other proxies may include, without limitation, IBANs (or other account numbers), government-issued identifiers (e.g., social security number, Aadhaar number, driver's license number, identify number, etc.).

In order to initiate the real-time transaction, the proxy is resolved into a payment account number, or token specific to the account from which funds are to be transferred. To do so, the participant 104A.1, for example, is configured, by the proxy service client 106A.1, to receive a proxy lookup request for the proxy of the recipient account. The proxy lookup request may be in the form of an application programming interface (API) call, or otherwise. In one example, the request may be consistent with one or more forms/formats, or based on specific instructions as to the form/format of the proxy lookup request. It should be appreciated, however, that the request may include a variety of information and also, specifically, the proxy. For instance, the request may also include a currency type for the given transaction (e.g., the sender may specify the particular currency in which they want to transact, etc.), which may be used to perform value based routing of the request/transaction, etc.

After receipt of the request, in this example embodiment, the participant 104A.1 is configured, by the proxy service client 106A.1, to submit the proxy lookup request to the proxy service core 102.1.

Based on the proxy lookup request, the proxy service core 102.1 is configured to perform a lookup for the proxy. This may include searching for the proxy in the local directory in the database 112.1, for example, depending on the proxy. The proxy service core 102 may also be configured to submit the proxy lookup requests to other participants in SCHEME.1, for example, or to submit the proxy lookup request to the proxy service core 102.2 of SCHEME.2 (e.g., broadcast the proxy lookup requests, etc.). Additionally, in this example embodiment, the proxy service core 102.1 is configured to submit the proxy lookup to multiple different third parties, i.e., the third party directory 108A.1, 108B.1, and 108C.1 in the SCHEME.1.

In connection therewith, the proxy service core 102.1 is configured to record the number of entities to which the proxy lookup request was submitted, as a number of expected responses, and to initiate an interval for response. The interval may be one second, five seconds, ten seconds, or other suitable interval consistent with the transaction associated with the proxy lookup (e.g., RTP transaction, etc.).

The third party directories 108A.1-108C.1 are configured to search in their respective directories and to submit a proxy lookup response back to the proxy service core 102.1. The proxy lookup response may indicate no proxy found, or may indicate account data associated with the proxy therein (e.g., IBAN, account number, etc.).

When the number of expected response is reached, or the interval for response is expired, the proxy service core 102.1 is configured to aggregate the received proxy lookup responses, whereby the aggregate proxy lookup response includes the proxy and the account data received from each of the third party directories, if any, and to submit the aggregate proxy lookup response to the participant 104A.1, or other provider of the proxy lookup request, in response to the proxy lookup request. For example, the proxy lookup request may have been received from the proxy service core 102.2, whereby the proxy service core 102.1 is configured to return the aggregate proxy lookup response back to the proxy service core 102.2, which in turn, is configured to return the aggregated proxy lookup response back to the participant in SCHEME.2, which submitted the proxy lookup request.

In this example, the participant 104A.1, as configured by the proxy service client 106A.1, (or other participant), returns the account data in response to the request. In this manner, the initiator of the proxy lookup request may solicit a selection of a particular account, from a holder of the proxy, as to which account, if multiple are present, to be used to receive funds in connection with the transaction.

It should be understood that after expiration of the interval to respond, the proxy service core 102.1 may receive one or more additional proxy lookup responses, from one or more entities (e.g., a third party directory 108, etc.). In that instance, in this example, the proxy service core 102.1 is configured to ignore the additional proxy lookup responses. However, in some examples, in response to the additional proxy lookup responses, the proxy service core 102.1 may be configured to aggregate, again, the proxy lookup responses and to submit the updated aggregate proxy lookup response to the participant 104A.1. The participant 104A.1, as configured by the proxy service client 106A.1, then, may return the account data to the initiator, or not, depending on the status of the transaction. For example, the participant 104A.1, as configured by the proxy service client 106A.1, may ignore the subsequent aggregated proxy lookup response, when the holder of the proxy has already selected an account for receipt of the funds.

It should be appreciated that the number of expected responses may include third party directories and also other participants within the scheme of the proxy service core 102. It should be further appreciated that the proxy service core 102 may be configured to submit the proxy lookup request to one or more other proxy service cores in other schemes and to likewise record a number of expected response and also initiate an interval for such responses. The proxy service core 102 may then be configured as described above related to responses from the other proxy service cores in the other schemes.

It should be further appreciated that, although the descriptions and examples provided herein relate to the resolution of proxies to account data, the parallel processing of requests and aggregation of responses may similarly apply to (or be used in connection with) any other action or functionality relating to the proxy and/or relating to RTP transactions herein. For instance, the lookup and/or broadcasting features of the present disclosure may additionally have applicability relating to, without limitation, requesting sanctions checks on parties associated with the transactions from multiple connected entities, requesting foreign exchange rates and fees from multiple providers to facilitate cross-border payments, requesting verification of one or more aspects of the transactions from multiple connected entities, requesting one or more identification attributes relating to the transactions from multiple connected entities, etc.

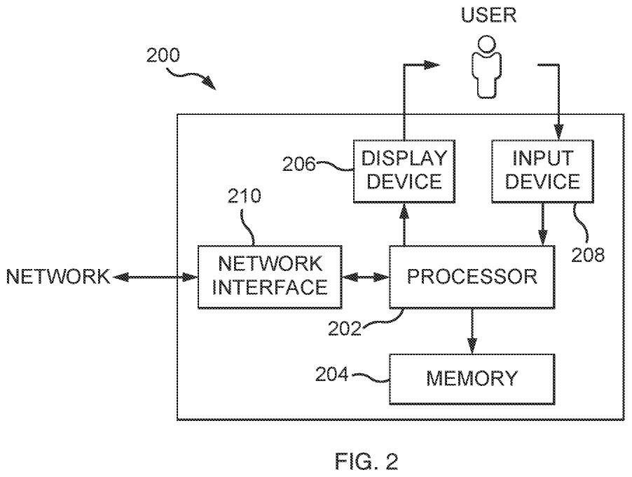

FIG. 2 illustrates an example computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, in each of the schemes, each of the proxy service core 102, the participants 104A-104B, the proxy service clients 106A-106B, the third party proxy directories 108, the databases 110, 112, and the message service, etc., may be considered, may include, and/or may be implemented in a computing device consistent with the computing device 200, coupled to (and in communication with) the one or more networks of the system 100. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, routing logic, proxies, account data, proxy directories, message formats/formatting, sequence stacks, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein (e.g., one or more of the operations of method 300, etc.), whereby upon (or in connection with) performing such operation(s) the computing device 200 may be transformed into a special purpose computing device. It should be appreciated that the memory 204 may include a variety of different memories, each implemented in one or more of the functions or processes described herein.

In the example embodiment, the computing device 200 also includes a presentation unit 206 and an input device 208.

The presentation unit 206 is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., account data, proxies, etc.), etc. And, various interfaces may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The input device 208 receives inputs from the user 112 (i.e., user inputs) of the computing device 200 such as, for example, inputs to register/define a proxy for an account, etc. The input device 208 may include a single input device or multiple input devices. The input device 208 is coupled to (and is in communication with) the processor 202 and may include, for example, one or more of a keyboard, a pointing device, a mouse, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth™ adapter, etc.), a mobile network adapter, or other device capable of communicating to one or more different networks herein and/or with other devices described herein. In some example embodiments, the computing device 200 may include the processor 202 and one or more network interfaces incorporated into or with the processor 202.

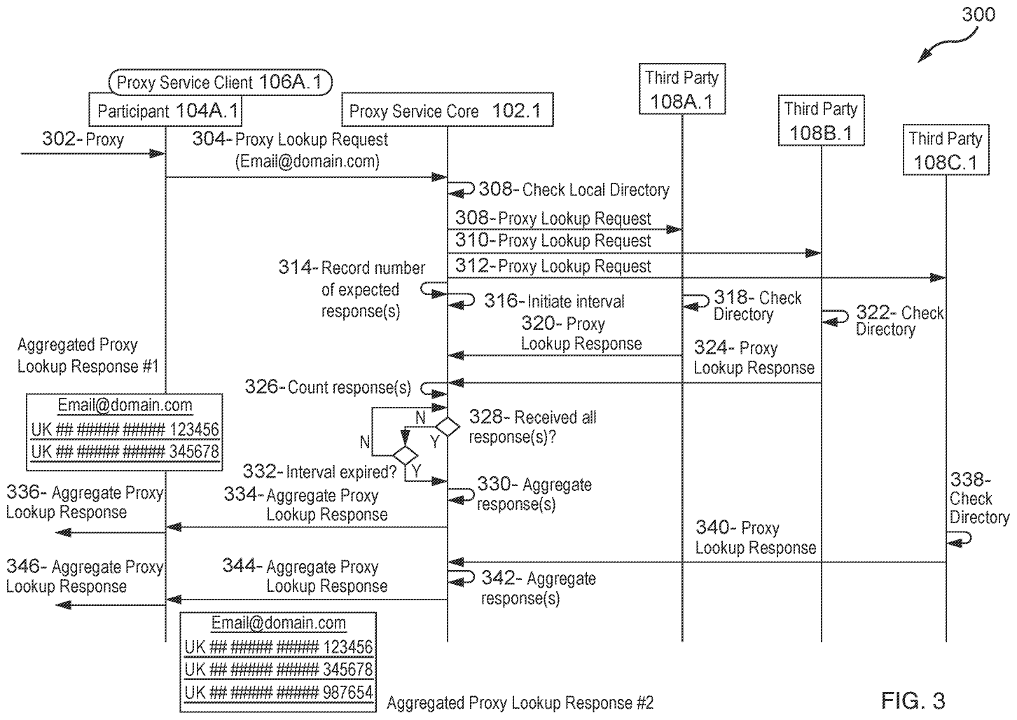

FIG. 3 illustrates an example method 300 for use in aggregate routing in response to a request associated with interconnecting directories. The example method 300 is described as implemented in system 100, and with additional reference to the computing device 200. That said, however, the methods herein should not be understood to be limited to the system 100 or the computing device 200, as the methods may be implemented in other systems and/or computing devices. Likewise, the systems and the computing devices herein should not be understood to be limited to the example method 300.

At the outset, in method 300, an initiator submits a proxy to the participant 104A.1, at 302, in connection with a RTP transaction, to transfer funds from the initiator to an account of a holder, which is linked to the proxy. In this example, the proxy includes an email address of the holder, such as, for example, email@domain.com. It should be understood, though, that other proxies may be used in other examples to identify the holder.

In response, the participant 104A.1, as configured by the proxy service client 106A.1, may optionally search for the proxy in a local proxy directory (e.g., in the database 110A.1, etc.), or not. If the proxy is not resolved at the participant 104A.1, the participant 104A.1, as configured by the proxy service client 106A.1, submits, at 304, the proxy lookup request to the proxy service core 102.1.

While the proxy lookup request is provided from the participant 104A.1 to the proxy service core 102.1 in this example, the proxy lookup request may be received by the proxy service core 102.1 from other entities in the system 100, including, for example, one or more different participants or the proxy service core 102.2, etc.

In response to the proxy lookup request, at 306, the proxy service core 102.1 searches for the proxy in the local proxy directory in the database 112.1. If not found in the local proxy directory, or potentially, even if found, the proxy service core 102.1 identifies one or more entities to which to submit the proxy lookup request. The entities may include other participants within the same, or a different scheme, etc. In this example embodiment, the proxy service core 102.1 identifies three third party directories, i.e., third party directories 108A.1-108C.1, which are associated services that may be able to resolve the proxy included in the proxy service request. As shown in FIG. 3, the proxy service core 102.1 submits the proxy lookup request to the third party directory 108A.1, at 308, and the proxy service core 102.1 submits the proxy lookup request to the third party directory 108B.1, at 310, and the proxy service core 102.1 submits the proxy lookup request to the third party directory 108C.1, at 312.

It should be appreciated that the proxy lookup request may be submitted, by the proxy service core 102.1, to more or less third party directories, or other entities in other method embodiments.

At 314, the proxy service core 102.1 records a number of expected responses, which is the same as the number of entities, cores, third parties, etc., to which the proxy lookup request is to be and/or was submitted. In addition, at 316, the proxy service core 102.1 initiates an interval for response, which may be two seconds, five seconds, ten seconds, or shorter or longer, depending, for example, on the implementation of the transaction for which the resolution of the proxy is required.

It should be appreciated that the order of submitting the proxy lookup request, recording the number of expected responses and/or initiating the interval may be in a different order in other embodiments.

As shown in FIG. 3, the third party directory 108A.1 checks for the proxy, at 318, and provides a proxy lookup response, at 320. The proxy lookup response may indicate that the proxy was not indicated in the directory, or the proxy lookup response may include account data associated with the proxy in the directory. Alternatively, the third party directory 108A.1 may not provide a proxy lookup response, where the proxy is not included in the directory. Similarly, the third party directory 108B. 1 checks for the proxy, at 322, and provides a proxy lookup response, at 324.

In connection therewith, the proxy service core 102.1 counts, at 326, the responses from the third party directories 108, as received therefrom. The counting, by the proxy service core 102.1, may be understood to be a decrement of the number of expected responses, or an increment of a count for comparison to the number of expected responses.

At 328, the proxy service core 102.1 determines if all the expected responses have been received. That is, in this example, the proxy service core 102.1 determines that the count of the response is the same as the number of expected responses, or that the number of expected responses has been decremented to zero. If yes, the proxy service core 102.1 aggregates, at 330, the received proxy lookup responses. The aggregating, in this example, is pulling each account data from the proxy lookup responses into a single proxy lookup response, i.e., an aggregate proxy lookup response. An example aggregate lookup response is illustrated in FIG. 3, and reference “Aggregated Proxy Lookup Response #1.” In this example, Aggregated Proxy Lookup Response #1 includes two different accounts, one identified by account data from each of the third party directories 108. It should be appreciated that, in other examples, one or more of the third party directories may not have account data, whereby less accounts may be included in the aggregated response. It should also be appreciated that, when the received responses include data other than account data (e.g., any other requested data in the method 300, for example, when reference data is used to define and/or identify other data; etc.), the other data may then also be aggregated, at 330, in a similar manner.

Alternatively, if not all the expected responses have been received, the proxy service core 102.1 determines, at 332, if the interval for response is expired. If not, the proxy service core 102.1 return to counting response. If yes, the proxy service core 102.1 proceeds to aggregate the proxy lookup response received at expiration. While determining the interval for response is expired or not is linked to determining whether all expected response have been received in FIG. 3, it should be appreciated that these determinations are not necessarily tied together, and may be independent of one another in various embodiments.

After aggregating the proxy lookup responses, the proxy service core 102.1 submits, at 334, the aggregate proxy lookup response to the proxy service client 106A.1 of the participant 104A.1 (or other entity that provided the proxy lookup request (e.g., the proxy service core 102.2, etc.)), in response to the proxy lookup request. The participant 104A.1, as configured by the proxy service client 106A.1, submits the proxy lookup response, at 336, to the initiator. The initiator may then present or inform the holder of the different accounts (which are linked to the proxy), to enable the holder to select one of the accounts, if more than one, to which the RTP transaction is to be directed. Thereafter, the proxy requestor may initiate the real time transaction to the account associated with the account data returned via the proxy lookup request, and selected, if necessary, by the holder.

Additionally, as shown in FIG. 3, the proxy service core 102.1 may receive a proxy lookup response after expiration of the interval for response. That is, at some time after the aggregate proxy lookup response is submitted back to the participant 104A.1, the third party directory 108C.1 checks, at 338, for the proxy in the directory and identifies associated or linked account data. The third party directory 108C.1 then submits the proxy lookup response, with the account data, back to the proxy service core 102.1, at 340.

Upon receipt of the proxy lookup response, i.e., a “late” proxy lookup response, the proxy service core 102.1 aggregates, at 342, the late proxy lookup response with the prior responses into a subsequent aggregated proxy lookup response. The subsequent aggregated proxy lookup response is illustrated in FIG. 3, and referenced as the “Aggregated Proxy Lookup Response #2.” As compared to Aggregated Proxy Lookup Response #1, Aggregated Proxy Lookup Response #2 include an additional account. At 344, the proxy service core 102.1 submits the proxy lookup response to the proxy service client 106A.1 of the participant 104A.1. The participant 104A.1, as configured by the proxy service client 106A.1, submits the proxy lookup response, at 346, to the initiator. That said, in other example embodiments, the proxy service core 102.1 may ignore any proxy lookup response received after the expiration of the interval for response.

It should be appreciated that a further interval may be imposed on proxy lookup responses, which may indicate that the late proxy lookup response, i.e., after the further interval for response, is not provided to the initiator or the participant 104A.1. For example, when the holder has selected an account, and the initiator has initiated the RTP transaction, any further proxy lookup responses may be ignored by the participant and/or not presented to the initiator. In another example, any response after thirty seconds, or one minute, or five minutes after the interval for response may be ignored by the proxy service core 102.1 and/or the participant 104A.1.

It should also be appreciated that encryption may be employed, optionally, in the method 300. As shown in FIG. 3, for instance, the encryption may be initiated prior to the third party directory 108A1 submitting the proxy lookup response to the proxy service core 102.1, at 320. Only the account data may be encrypted in this example, or the account data and other data may be encrypted in other examples.

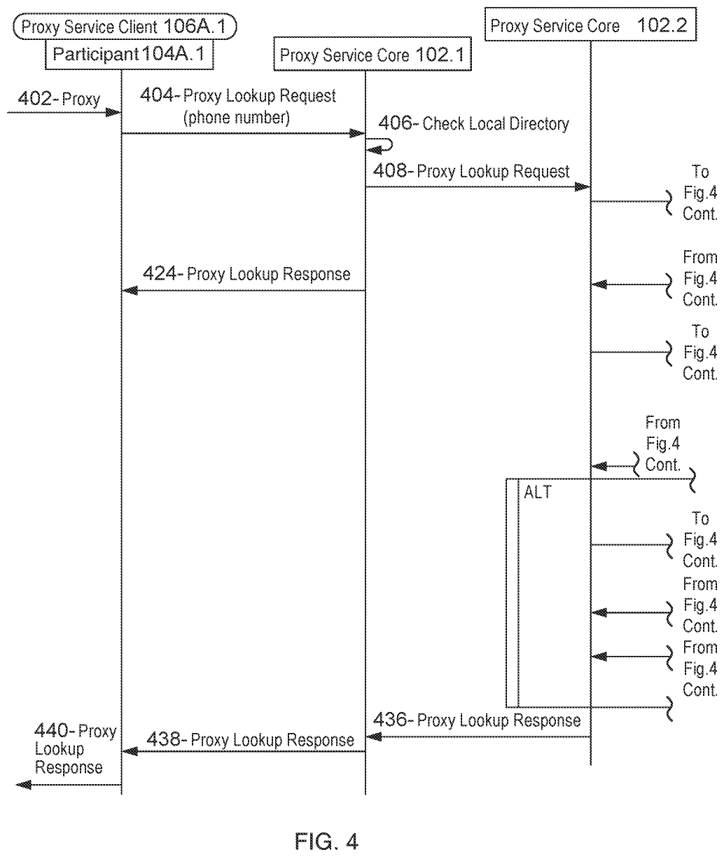

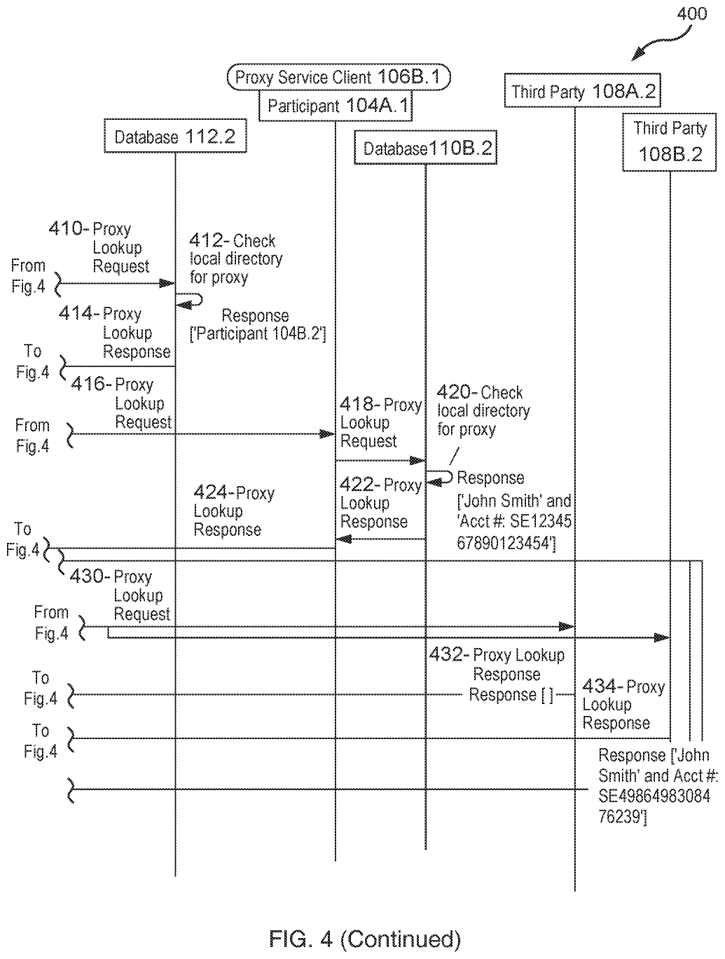

FIG. 4 illustrates another example method 400 for use in resolution of proxies across multiple different schemes. The example method 400 is described as implemented in system 100, and with additional reference to the computing device 200. That said, however, the methods herein should not be understood to be limited to the system 100 or the computing device 200, as the methods may be implemented in other systems and/or computing devices. Likewise, the systems and the computing devices herein should not be understood to be limited to the example method 400.

At the outset, in method 400, it should be understood that the interactions are illustrated between different ones of the schemes of FIG. 1, as indicated by the specific reference of the proxy service core 102.1 and proxy service core 102.2, for example. As such, the method 400 involves steps being performed across border, for example, different schemes. It should be appreciated that the method 400 may be applicable and/or associated with other pairs of participants in different schemes, without limitation.

Initially, an initiator submits, at 402, a proxy lookup request to the participant 104A.1 (e.g., via a banking application, etc.). The proxy lookup request includes the proxy. The proxy in this example includes a phone number, which is linked to a holder and an account of that holder to which the initiator is attempting to send funds (e.g., as part of a real time payment (RTP) transaction, etc.). The request may include, specifically, data indicative of Proxy Type: Phone and the Proxy: +46 ## ## ## ## ##.

The participant 104A.1, as configured by the proxy service client 106A.1 (and/or message service 114.A.1), may determine that the proxy is not in the local directory of the proxy service client 106A.1 (e.g., is not in database 110A.1, etc.) (e.g., by a search or one or more rules, etc.) and may transform the proxy lookup request to an internal format. For instance, the proxy lookup request may be seen as an account verification request using an inline proxy resolution. As such, the participant 104A.1, for example, using the ISO 20022 message set, may submit an acmt.023.001.xx message to the proxy service client 106A.1 whereby the message service 114A.1 transforms the acmt.023 into an internal canonical form for communication with the proxy service core 102.1 and other participants.

The participant 104A.1, as configured by the proxy service client 106A.1 submits, at 404, the proxy lookup request (transformed) to the proxy service core 102.1.

The proxy service core 102.1 checks, at 406, that the proxy is not in the local directory (e.g., by a search of database 112.1 or based on one or more rules, etc.), and then, the proxy service core 102.1 submits the proxy lookup request to the proxy service core 102.2, at 408. In particular, the proxy service core 102.1 may rely on one or more routing rules, or not, that may indicate a specific scheme to which the proxy lookup request is to be submitted. Here, in this example, the proxy service core 102.1 may rely on the +46 country code of the proxy to identify SCHEME.2, for instance, specific to Sweden.

In turn, the proxy service core 102.2 submits the proxy lookup request to the database 112.2, at 410. The database 112.2 then checks, at 412, the local directory for the proxy. Because the proxy is local to SCHEME.2, the database 112.2 includes, in the local directory, the proxy and also the name of the participant to which the proxy is registered, Participant 104B.2. In other examples, the proxy directory within the database 112.2 may include other information specific to the participant, or potentially, the holder (e.g., name, etc.). The response, including that data, is returned to the proxy service core 102.2, at 414. Then, the proxy service core 102.2 submits, at 416, the proxy lookup request to the participant 104B.2. The proxy lookup request may include the proxy, and may further include the name from the local directory.

The participant 104B.2 submits the proxy lookup request to the database 110B.2, at 418. The database 110B.2 then checks, at 420, the local directory for the proxy. Because the proxy is local to SCHEME.2, and specific to the participant 104B.2, the database 110B.2 includes, in the local directory, the proxy and also the name of the holder, John Smith, and the account number for the holder. The response, including that data, is returned to the participant 104B.2, at 422. Then, the participant 104B.2 submits, at 424, the proxy lookup response to the proxy service core 102.2.

Alternatively, or optionally, as illustrated in FIG. 4, the proxy service core 102.2 may rely on one or more routing rules, for example, based on the proxy, and submits, at 430, the proxy lookup request to each of the third parties in SCHEME.2, which include, in this example, third party proxy directories 108A.2 and 108B.2. It should be appreciated that the proxy service core 102.2 may transform the proxy lookup request, as necessary, for each of the third party proxy directories 108A.2 and 108B.2, i.e., from an internal format to a format specific to one or both of the third party proxy directories 108A.2 and 108B.2.

In this example, the third party proxy directory 108A.2 searches for the proxy and finds no match, whereby a proxy lookup response is provided to the proxy service core 102.2, at 432, which is empty. Conversely, the third party proxy directory 108B.2 searches for the proxy and finds the proxy linked to an account therein. The third party proxy directory 108B.2 then provides, at 434, a proxy lookup response, which includes the account number for the account, to the proxy service core 102.2.

Again, the proxy service core 102.2 may transform the proxy lookup response to an internal format, from the format in which each was provided from the third party proxy directories 108A.2 and 108B.2.

It should be appreciated that the proxy lookup request may be disseminated (transformed or not) by the proxy service core 102.2 to any combination of participants and/or third party proxy directories, depending, for example, on what is indicated in the local directory of the proxy service core 102.2 (in the database 112.2). Likewise, while the proxy service core 102.1 identified the proxy service core 102.2 in the example above, it should be understood that the proxy service core 102.1 may not identify any particular scheme, and instead submit the proxy lookup request to multiple different schemes (e.g., to the proxy service cores 102 of SCHEME.2 and SCHEME.3, etc.). In this manner, it should be understood that the proxy lookup request may be submitted to all schemes, or less, depending on what the proxy service core 102 is able to determine about the potential resolution of the proxy included therein.

Thereafter, regardless of the whether the proxy is linked/registered by a participant or the third party, in this example, the proxy service core 102.2 returns, at 436, the proxy lookup response to the proxy service core 102.1. And, the proxy service core 102.1 returns, at 438, the proxy lookup response to the participant 104A.1, and in particular, to the proxy service client 106A.1, which transforms (optionally, not shown) the internal format of the proxy lookup response back to a format specific to the participant 104A.1. In turn, at 440, participant 104A.1 returns the proxy lookup response to the initiator. Thereafter, the initiator may initiate the RTP transaction to the account associated with the account data returned via the proxy lookup response. For instance, from the above example where the proxy lookup request may be an account verification request, the message service 114A.1 associated with the proxy service client 106A.1 may transform the internal canonical message into an ISO 20022 acmt.024.001.xx message specific to the participant 104A.1, and which is then transmitted (at 440) to the initiator.

In the above example, the request originates from the participant 104A.1. It should be appreciated, though, that this is not required in all embodiments. For instance, the request may be initiated from a third party in other examples, etc.

In view of the above, the systems and methods herein provide a single access point which connects participant banks to local directory services, both in connection with other participants, as hosted by the service core, and also third party directories, in the same or other regions. As such, a global network of loosely connected participants is provided, with suitable data access controls, as applied in the proxy service core, or elsewhere, whereby any participant is permitted to send payment related messages to any other participant, either directly in the form of messages such as proxy resolution or account verification, or via a local payment switch in the form of real time payments.

In addition, the systems and methods herein provide for aggregating reference data lookup responses. In this manner, several different data sources may be involved, for example, in the resolution of a proxy, in verifying accounts, in confirming payees, in providing sanction checks against names, etc. without numerous responses being individually, separately submitted to the participants and/or initiators. Instead, each response is aggregated to a single response (when the interval for response is observed), whereby the amount of network traffic to the participant and/or initiator is reduced. What's more, the options associated with the transaction, by the initiator, for example, in connection with the holder of the reference data, is also simplified and reduced. That is, the aggregation provides for the return of a complete listing of the desired data in a reduced time, whereby efficiencies in network traffic and latency are gained to preserve and/or enhance real time responsivity of the service. Real time, in this content, refers to within milliseconds, a second, two seconds, and up to one minute, whereby RTP transaction are initiated, cleared and settled within that time.

It should be appreciated that the service cores as described above permit a network of participants and directories to be established in one or more schemes, which may or may not be interconnected. Additionally, or alternatively, the service cores as described above permit messaging between third parties (e.g., real-time payment services, etc.) in the same scheme or among different schemes. As such, the service cores, based on a combination of the above, define the global network, which may respond to suitable requests related to proxies or other reference data.

Further, the proxy service cores and/or associated proxy service clients provide for multiple connectivity types and/or multiple message formats, security mechanisms etc., which permits initiators to submit messaging in the form most relevant to the scheme to which the initiator/participant belongs. The proxy service cores and/or associated proxy service clients then transform these messages into the internal, canonical, format, which is to be exchanged within the service cores in different schemes, especially in other regions. Based on the internal format, the proxy service cores are permitted to understand the messaging and transform, as necessary, the messaging to a format used by the particular region in which they are located and forward to the receiving third party and/or participant.

The proxy service core and/or associated proxy service client may be constructed into a network of services across numerous regions, with each service core connected to local payment services, third parties, and/or participants.

What's more, in one example embodiment, a computer-implemented method for use in resolution of proxies across multiple different schemes, the method includes: (a) receiving, by a computing device, from a participant, a proxy lookup request, the proxy lookup request including a proxy; (b) transforming the proxy lookup request from a first format into a second format, the first format different than the second format; (c) based on one or more routing rules, submitting, by the computing device, the proxy lookup request, in the second format, to a proxy service core computing device; (d) receiving, by the computing device, from the proxy service core computing device, a proxy lookup response, which includes account data linked to the proxy; and (e) returning, by the computing device, the proxy lookup response, to the participant, in response to the proxy lookup request.

In another example embodiment, a computer-implemented method includes: (a) receiving, by a computing device, from a participant, a lookup request, the lookup request including reference data; (b) transforming the lookup request from a first format into a second format, the first format different than the second format; (c) based on one or more routing rules, submitting, by the computing device, the lookup request, in the second format, to a service core computing device; (d) receiving, by the computing device, from the service core computing device, a lookup response, which includes account data linked to the reference data; and (c) returning, by the computing device, the lookup response, to the participant, in response to the lookup request.

Either of the computer-implemented methods above may include, alone or in any suitable combination: (a) wherein the reference data includes a proxy; (b) wherein the proxy includes a phone number or an email address; (c) herein the first format includes an ISO 20022 standard format; (d) submitting, by the proxy service core computing device, the proxy lookup request in the second format, to a different proxy service core computing device, in a different scheme than the proxy service core computing device; receiving, by the proxy service core computing device, the proxy lookup response from the different proxy service core computing device; and submitting, by the proxy service core computing device, the proxy lookup response to the computing device; (e) wherein the proxy service core computing device is located in a first country, and the different proxy service core computing device is located in a second country, different than the first country; and/or (f) further comprising transforming the proxy lookup response from the second format into the first format, prior to returning the proxy lookup response to the participant; etc.

It should be appreciated that a non-transitory computer-readable storage medium comprising executable instructions for resolution of proxies, which when executed by at least one processor, cause the at least one processor to perform any of the computer-implemented methods above, alone or in any suitable combination. It should also be appreciated that a system may include a computing device (e.g., proxy service core, proxy service client, etc.) configured to perform any of the computer-implemented methods above, alone or in any suitable combination.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the operations recited in the claims, such as, for example: (a) receiving, from a participant, a proxy lookup request, the proxy lookup request including a proxy; (b) submitting the proxy lookup request to each of multiple directories; (c) determining that a proxy lookup response has been received from each of the multiple directories; and in response, (d) aggregating the proxy lookup responses into an aggregate proxy lookup response; and/or (c) returning the aggregate proxy lookup response, to the participant, in response to the proxy lookup request.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the operations recited in the claims, such as, for example: (a) receiving, from a participant, a lookup request, the lookup request including reference data; (b) submitting the lookup request to each of multiple directories, whereby each of the multiple directories uses the reference data included in the lookup request to identify other data; (c) determining that a lookup response has been received from each of the multiple directories; and (d) aggregating the other data included in the lookup responses into an aggregate lookup response; and/or (c) returning the aggregate lookup response, to the participant, in response to the lookup request.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the operations recited in the claims, such as, for example: (a) receiving, by a computing device, from a participant, a proxy lookup request, the proxy lookup request including a proxy; (b) transforming the proxy lookup request from a first format into a second format, the first format different than the second format; (c) based on one or more routing rules, submitting, by the proxy service core computing device, the proxy lookup request, in the second format, to a proxy service core computing device; (d) receiving, by the computing device, from the proxy service core computing device, a proxy lookup response, which includes account data linked to the proxy; and/or (c) returning, by the computing device, the proxy lookup response, to the participant, in response to the proxy lookup request.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the operations recited in the claims, such as, for example: (a) receiving, by a computing device, from a participant, a lookup request, the lookup request including reference data; (b) transforming the lookup request from a first format into a second format, the first format different than the second format; (c) based on one or more routing rules, submitting, by the computing device, the lookup request, in the second format, to a service core computing device; (d) receiving, by the computing device, from the service core computing device, a lookup response, which includes account data linked to the reference data; and/or (c) returning, by the computing device, the lookup response, to the participant, in response to the lookup request.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in aggregate routing in response to a request associated with interconnecting directories, the system including a computing device configured, by executable instructions, to:
receive, from a participant, a proxy lookup request, the proxy lookup request including a proxy;
submit the proxy lookup request to each of multiple directories;
determine that a proxy lookup response has been received from each of the multiple directories; and
in response to determining that the proxy lookup response has been received from each of the multiple directories:
aggregate the proxy lookup responses into an aggregate proxy lookup response; and
return the aggregate proxy lookup response, to the participant, in response to the proxy lookup request.

2. The system of claim 1, wherein the proxy includes one of a phone number and an email address.

3. The system of claim 1, wherein the computing device is configured, by the executable instructions, to:
initiate an interval for response; and
determine that the interval for response is expired; and
in response to determining that the interval for response is expired:
aggregate the proxy lookup responses into the aggregate proxy lookup response; and
return the aggregate proxy lookup response, to the participant, in response to the proxy lookup request.

4. The system of claim 3, wherein the computing device is configured, by the executable instructions, to initiate the interval for response when the proxy lookup request is submitted to each of the multiple directories.

5. The system of claim 3, wherein the computing device is configured, by the executable instructions, to:
receive a late proxy lookup response, after expiration of the interval for response;
aggregate the late proxy lookup response with the proxy lookup responses into a subsequent aggregate proxy lookup response; and
return the subsequent aggregate proxy lookup response, to the participant.

6. The system of claim 1, wherein the computing device is configured, by the executable instructions, to record a number of expected responses based on the multiple directories; and
wherein, in order to determine that a proxy lookup response has been received from each of the multiple directories, the computing device is configured, by the executable instructions, to determine the number of proxy lookup responses received is the same as the number of expected responses.

7. The system of claim 1, wherein the computing device is configured, by the executable instructions, to aggregate account data included in each of the proxy lookup response into the aggregate proxy lookup response.

8. The system of claim 1, wherein the multiple directories include third party directories associated with a mobile payment provider; and
wherein the computing device includes a proxy service core computing device.

9. The system of claim 1, wherein the multiple directories include one or more of: a proxy service client, a proxy service core, and/or a third party proxy directory.

10. A computer-implemented method for use in aggregate routing in response to a request associated with interconnecting directories, the method comprising:
receiving, by a proxy service core computing device, from a participant, a lookup request, the lookup request including reference data;
submitting, by the proxy service core computing device, the lookup request to each of multiple directories, whereby each of the multiple directories uses the reference data included in the lookup request to identify other data;
initiating, by the proxy service core computing device, an interval for response;
determining, by the proxy service core computing device, that a lookup response has been received from each of the multiple directories or that the interval has expired; and
in response to the determination:
aggregate, by the proxy service core computing device, the other data included in the lookup responses into an aggregate lookup response; and
return the aggregate lookup response, to the participant, in response to the lookup request.

11. The computer-implemented method of claim 10, wherein the reference data includes a proxy.

12. The computer-implemented method of claim 11, wherein the proxy includes one of a phone number and an email address.

13. The computer-implemented method of claim 10, wherein initiating the interval for response includes initiating the interval for response when the lookup request is submitted to each of the multiple directories.

14. The computer-implemented method of claim 10, further comprising:
receiving, by the proxy service core computing device, a late lookup response, after expiration of the interval for response;
aggregating, by the proxy service core computing device, the late lookup response with the lookup responses into a subsequent aggregate proxy lookup response; and
returning, by the proxy service core computing device, the subsequent aggregate proxy lookup response, to the participant.

15. The computer-implemented method of claim 10, further comprising:
recording, by the proxy service core computing device, a number of expected responses based on the multiple directories; and
wherein determining that a proxy lookup response has been received from each of the multiple directories includes determining the number of proxy lookup responses received is the same as the number of expected responses.

16. The computer-implemented method of claim 10, further comprising aggregating, by the proxy service core computing device, account data included in each of the lookup responses into the aggregate lookup response.

17. The computer-implemented method of claim 16, wherein the multiple directories include third party directories associated with a mobile payment provider.

18. A non-transitory computer-readable storage medium comprising executable instructions, which when executed by at least one processor, cause the at least one processor to:
receive, from a participant, a lookup request, the lookup request including reference data;
submit the lookup request to each of multiple directories, whereby each of the multiple directories uses the reference data included in the lookup request to identify other data;
determine that a lookup response has been received from each of the multiple directories; and
in response to determining that the lookup response has been received from each of the multiple directories:
aggregate the other data included in the lookup responses into an aggregate lookup response; and
return the aggregate lookup response, to the participant, in response to the lookup request.
